(19) United States
(12) Patent Application Publication
(10) Pub. No.: US 2022/0172312 A1
(43) Pub. Date: Jun. 2, 2022

(54) SYSTEM AND METHOD OF APPRENTICESHIP PROGRAM MANAGEMENT

(71) Applicant: OCAS, Guelph (CA)

(72) Inventors: Karen Jean CREDITOR, Fergus (CA); Benjamin Peter James HARPER, Guelph (CA); Elizabeth Lee Jean MCFAUL, Kitchener (CA); Shawn Maurice ROBINSON, Cambridge (CA); Alissa May Buchanan ROBSON, Guelph (CA); Tudor Alexander WHITELEY, Puslinch (CA); Mark Gregory WILHELM, Baden (CA); Michael Arman WILLIAMSON, Guelph (CA)

(73) Assignee: OCAS, Guelph, ON (CA)

(21) Appl. No.: 17/445,015

(22) PCT Filed: Feb. 27, 2020
(86) PCT No.: PCT/CA2020/050262

§ 371 Date: Aug. 13, 2021

Related U.S. Application Data
(63) Continuation of application No. 16/286,720, filed on Feb. 27, 2019.
Application No. 16/286,720 is a continuation of application No. 16/286,676, filed on Feb. 27, 2019.
(60) Provisional application No. 62/813,703, filed on Mar. 4, 2019.

(51) Int. Cl. G06Q 50/20; G06Q 20/02; H04L 67/306; G06Q 30/02

(52) U.S. Cl. CPC G06Q 50/2053; G06Q 30/0282; H04L 67/306; G06Q 20/02

(57) ABSTRACT

An apprenticeship system enabling all stakeholders involved (apprentice, sponsor/employer, TDA) to access a single system to assist an apprentice through the different phases of apprenticeship journey, including Account Creation, Registration (Application & Preparation), In-Class Training, On-The-Job Training (Personalized Logbook), Membership & Certification and Reporting. An apprenticeship system may be built on a common data model so that information is shared across the system for all users, tasks, and business processes. The system may consolidate all data about the apprentice journey in a single location, allowing for real-time data exchange among stakeholders. The system may provide for aggregate data and reporting about the apprenticeship system as a whole, including insights on the performance of apprentices, employers, and training agents; capacity/demand planning & enrollment projections for the trades; and trade-specific performance metrics to inform policy and curriculum considerations.

### CROSS REFERENCE TO RELATED APPLICATIONS

This application is a National Phase application that claims priority to and the benefit of the international PCT Patent Application No. PCT/CA2020/050262 entitled “SYSTEM AND METHOD OF APPRENTICESHIP PROGRAM MANAGEMENT”, filed on Feb. 27, 2020, and U.S. application Ser. No. 16/286,720, entitled “SYSTEM AND METHOD FOR MULTI-INSTITUTIONAL OPTIMIZATION FOR A CANDIDATE APPLICATION SYSTEM”, filed on Feb. 27, 2019, and U.S. application Ser. No. 16/286,676, entitled “SYSTEM AND METHOD FOR ACHIEVING CANDIDATE DIVERSITY IN A CANDIDATE APPLICATION SYSTEM”, filed on Feb. 27, 2019 and U.S. provisional application Ser. No. 62/813,703, entitled “SYSTEM AND METHOD OF APPRENTICESHIP PROGRAM MANAGEMENT”, filed on Mar. 4, 2019, which are hereby incorporated by reference in their entirety.

### BACKGROUND

The embodiments described herein relate to candidate application systems and more particularly, to a system and method for apprenticeship program application and management.

The journey from choosing to become an apprentice and completing training and obtaining certification is a long and complex process, involving many stakeholders. The processes and interactions on this journey and among these groups can be confusing and frustrating. A modernized technology interface is a small but critical element in improving communication and interaction among all stakeholders.

There are many issues related to apprenticeship programs. Apprenticeship candidates find it challenging to find information on how to become an apprentice and navigate multiple registration steps. Employers find it challenging to identify and recruit candidates for apprenticeship in some trades. There are multiple systems in which to maintain and manage personal information; some apprentices miss critical communications or opportunities as a result of out-of-date personal information.

Further, training delivery agents (TDAs) such as colleges, universities and vocational schools, and employers, and apprentices are equally frustrated with planning and communication around in-class training. Employers have little input on timing of in-class training, making it difficult to plan for employee absences. TDAs are also challenged to manage seats and inflow without the ability to predict and engage with apprentices. TDAs are not able to provide support services without advanced contact with apprentices, so apprentices may not be able to take advantage of existing support services offered (such as a college's accessibility services or math upgrading).

Furthermore, Apprentices are required to keep an inconvenient paper logbook on hand to receive sign-offs. As a result, many apprentices (especially in voluntary trades) are not diligent in completing the logbook. As well, the logbook may be lost or left for signature with an employer who goes out of business. These incidents may stall or set back a student's progress in the apprenticeship program. A system to address at least some of these deficiencies is contemplated.

Throughout this document, references to the Ministry should be understood to refer to the government ministry or ministries, or department or departments which have oversight of the relevant aspects of apprenticeship and training, or which are responsible for all or part of the relevant computing systems and processes discussed herein. These may be one or more of the Ministry of Labour, the Ministry of Education, the Ministry of Labour, Training and Skills Development, the Ministry of Training, Colleges and Universities, the Department of Education, the Department of Labour, or any other government ministries or departments.

Throughout this document, references to jurisdiction should be understood to refer to the political entity or entities having jurisdiction or control over all or part of the relevant aspects of apprenticeship and training, such as the Province of Ontario.

### SUMMARY

An apprenticeship system enabling all stakeholders involved (apprentice, sponsor/employer, TDA) to access a single system to assist an apprentice through the different phases of apprenticeship journey, including Account Creation, Registration (Application & Preparation), In-Class Training, On-The-Job Training (Personalized Logbook), Membership & Certification and Reporting. An apprenticeship system may be built on a common data model so that information is shared across the system for all users, tasks, and business processes. The system may consolidate all data about the apprentice journey in a single location, allowing for real-time data exchange among stakeholders. The system may provide for aggregate data and reporting about the apprenticeship system as a whole, including insights on the performance of apprentices, employers, and training agents; capacity/demand planning & enrollment projections for the trades; and trade-specific performance metrics to inform policy and curriculum considerations.

A system with a connected data model improves metrics and reports across the entire apprenticeship system to aid in strategic decision-making, enabling far-reaching efficiencies for education and work ecosystems. A registration aspect of the system may allow apprenticeship applicants, employers, TDAs and government staff (from the ministry or government department governing education or skill development) to access a single system to perform tasks related to the apprenticeship registration process. Applicants may create and maintain a profile which may include details such as their personal information, employment information and desired trade. Employers may create and maintain a profile which may include details such as their company's information and information on apprentices and journeypersons. Government (Ministry) users may use facilities in the registration system to view existing apprentices and sponsors, approve apprentices who have applied or registered, and approve and manage new sponsors.

A logbook aspect of the system may allow the recording of completion of competencies attained or time worked, and allows for the approval of those competencies or hours by both the apprentice and the employer. This aspect is preferably implemented as a native mobile application, but may also be a mobile-accessible website running on a centralized system or systems, a mobile application which communicates with a centralized system or systems, a desktop-accessible website running on a centralized system or systems, a desktop application which communicates with a centralized system or systems, or any combination of these (for example, one implementation may be a centralized system which communicates with mobile applications and which serves a desktop-accessible website). The system may track skills based on demonstrated experience, as opposed to self-declared skills common in other applications. The system may also track micro-learning experiences. An off-line tracking mode allows for the ability to log competencies or hours, and to approve competencies or hours, without a connection to the central system, by storing local updates as they are made and then reconciling them with the central system's data when a connection becomes available. Notifications may be generated to indicate what skills the apprentice should pursue next, when an apprentice is ready to move to another level of training, or for any other update or milestone reached in the apprenticeship process. These notifications may be in-application notifications (such as badges or pop-ups), SMS messages, email messages, or some other kind of notifications. A reporting facility within this system allows reporting across trades, trade levels or employers which allows, for example, the identification of skill gaps at certain employers.

An in-class seat registration aspect of the system may allow for centralization of seat management for all participating institutions. This may allow for recommendations of courses for apprentices based on course availability, location, level, the apprentice's level of training or other factors. The system may notify stakeholders (TDAs, employers, apprentices, government staff) about the apprentice's readiness to move forward with training, registration and seat availability, and approvals from employers. The system may record apprentice progress and success in one system, with visibility and reporting of these to stakeholders. The system may recommend interventions, mentors or courses for students, based on student success, student progress, mentor availability, course availability, location, level, apprentice readiness for training or other factors. The system may be enabled to optimize the allocation of seats across TDAs and geographic areas.

A certification aspect of the system may allow for the validation and management of validation of an apprentice's courses, competencies, hours, or other requirements or certifications (such as First Aid, Work at Heights, etc.). The system may be enabled to allow the apprentice, employer, government staff, TDA staff or others to have visibility into an apprentice's progress through the apprenticeship process. This visibility may be affected by privacy restrictions, agreements or other arrangements, and the system may filter or aggregate the information presented in each case based on these arrangements. The system may allow for real-time reporting for stakeholders on upcoming certifications and apprentice results, as well as aggregate data on the performance of apprentices, employers, specific competencies or courses against certification results. The system may be enabled to allow government staff to better predict the number of people in any skilled trade. The system may be enabled to report on correlations between examination results and programs, employers or TDAs.

A business intelligence and reporting aspect of the system may allow for the collection of data pertaining to the apprenticeship process and the generation of reports presenting and analyzing this data. The system is enabled to provide enrolment projections and capacity/demand planning for in-class training sessions, by trade, by TDA and by geographical availability or distribution of TDAs; information on the performance of and geographical availability of sponsors, with the ability to analyze the success of on-the-job training across trades; aggregate data on the performance of apprentices, employers, and training agents; aggregate data on the performance of a specific trade, allowing for changes and enhancements in required skills and associated coursework; and other reporting functions.

### BRIEF DESCRIPTION OF THE DRAWINGS

FIG. 1 is a model representing different stakeholder's journey through an apprenticeship system.

FIG. 2 illustrates a screen that shows functionality for each core persona.

FIG. 3 is a flow diagram representing an apprentice's journey through an apprenticeship system.

FIG. 4 is a flow diagram representing a training delivery agents (TDA)'s journey through an apprenticeship system.

FIG. 5 is a flow diagram representing an employer's journey through an apprenticeship system.

FIG. 6 is a flow diagram representing an apprentice and employer workflow.

FIG. 7 is a block diagram illustrating an exemplary apprenticeship system.

FIG. 8 is a block diagram illustrating functional components of an exemplary apprenticeship system.

FIG. 9 is a block diagram illustrating structural components of an exemplary apprenticeship system.

FIG. 10 is a block diagram illustrating an interfacing between an exemplary apprenticeship system and an exemplary college application system, both feeding data into a Data+Analytics Services module.

FIG. 11 illustrates login/home screen of the apprenticeship system.

FIG. 12 illustrates the Manage Training screen that demonstrates how a training agent (TDA) would offer tranches of training, manage enrollment, and view participants

FIG. 13 illustrates a screen that shows how an apprentice could search for in-class training sections, as well as some of the notifications that could be present in the system.

FIG. 14 illustrates a screen that shows the apprentice's view of scheduling of the Certification of Qualification (CofQ) exam.

FIG. 15 illustrates a screen where an apprentice could view employers that are looking for apprentices.

FIG. 16 is an example of reporting dashboard technology.

FIGS. 17A to 17F are diagrams illustrating exemplary screenshots of a digital logbook application.

FIG. 18 illustrates how an employer might approve their apprentice's skill signoffs in bulk.

### DETAILED DESCRIPTION

In today's apprenticeship ecosystem, there are various issues driving the impetus for modernization. Existing apprenticeship ecosystems may be overly complex to navigate, with numerous stakeholders and systems that aren't integrated. A modernized system should facilitate integration of information amongst the stakeholders and existing systems.

The process for obtaining a Registered Training Agreement (RTA) is difficult as the system is still based on a physical signed paper being sent between stakeholders, rather than a digital contract. Implementing a digital contract system would simplify this step and facilitate timelier sharing of this information to interested stakeholders within the apprenticeship system.

Despite current marketing efforts, new apprenticeship candidates find it challenging to locate information about the trades and the process for applying to become an apprentice. For apprentices who manage to enter the system, continuously navigating from the jobsite, to classroom, and back to the jobsite over several years can be confusing to apprentices and their employers. There are multiple sources of information and multiple paths; a modernized system should provide clear and connected guidance through the process, regardless of which path the apprentice has chosen.

Across many trades and technology fields, employers find it challenging to identify and recruit candidates for apprenticeship. There is a perceived lack of support for apprentices throughout the system. For example, apprentices have to apply and maintain their personal information through multiple systems that are not integrated. It becomes difficult to stay in touch with apprentices if their address and contact information changes and is not kept up-to-date in each system. A modernized, integrated information-sharing system designed primarily around the needs of apprentices will significantly improve the support level for apprentices.

Colleges struggle to manage seats and inflow without the ability to predict and recruit apprentices, despite having existing robust systems and capabilities in place for other, standard non-apprenticeship post-secondary college reporting. Long waitlists for some in-school training make life plans challenging and frustrating for apprentices leading to abandonment of the apprenticeship path and lowered completion rates. With current rigid scheduling rules for in-class training, apprentices are challenged to be able to take time away from work with limited notice. Both employers and apprentices are frustrated with long term planning.

Sponsors are given little to no input on the timing of in-class training sessions, making it difficult to effectively plan around the absences of apprentices who have received notification to attend class training. Sponsors may be left with limited staff resources during these periods. A class planning system that takes into account the needs of the apprentice, their sponsor and the TDA would help all of these stakeholders effectively plan for this in class training.

With no advanced contact, TDAs are not able to provide apprentices with information on support services (such as accessibility services or math upgrading courses) that could assist them in their apprenticeship journey. For example, some apprentices may not have the English literacy and math skill levels necessary for successful completion of the in-class component of apprenticeship training TDAs are unaware of this until apprentices begin in-class training, giving them insufficient time to effectively engage these students with their support systems.

Support services available to regular post-secondary students, including counselling services, tutoring and parking permits, may not be as easily accessible for apprentices and/or may only be available during standard postsecondary terms, which do not always align with in-class training sessions. An interconnected, accessible system that facilitates planning for in-class training would enable TDAs to prepare to have effective support systems in place for apprentices.

Apprentices are required to carry a physical logbook to receive sign-offs; an inconvenient format is prone to loss or damage. Many apprentices (especially those in voluntary trades) quickly lose momentum or fail to complete their logging.

Apprentices were required to remember to renew their membership by paying the annual fee. With their contact information stored in multiple systems that aren't integrated, apprentices may not have received payment reminders from the ministry if their contact information is outdated. Approximately 20% of suspensions from apprenticeship programs were due to non-renewal of their membership. A system that provides accurate and timely notifications electronically would significantly alleviate this issue. Hidden costs arising from inefficiencies (such as manual processing of paper forms) drain funds unnecessarily from those supporting apprentices on their path to becoming certified tradespeople.

Furthermore, there are many stakeholders involved in apprenticeship who will be impacted by any changes. For example: apprentices, the responsible government ministry, Training Delivery Agents (TDAs), sponsors (employers), counsellors, and influencers such as parents. There are hidden costs for all involved as they try to support the apprentice navigating the system. A modernized, easily accessible apprentice system should make the process more efficient and cost effective for everyone involved.

Many stakeholders are vested in the apprenticeship system today, each working and supporting the apprentice in their pathway to journeyman. The synergy and efforts of all stakeholders is required for the system's modernization. The following is a list of each stakeholder involved in apprenticeship, based on their perceptions and professional experience, in order to ensure the modernized system includes features important to all.

Apprentices:
More control over in-school training through access to training offerings available through their chosen TDAs or colleges
Improved support model with direct communication from TDAs to their apprentices
Improved access to information about the apprenticeship system and how to navigate it
A single, clear, visible pathway through apprenticeship and clear tracking of their progress against it
Systems that support:
   Accessibility and responsiveness across all devices (computers, tablets and phones)
   Simplified points of contact and simplified ways of completing the various steps in the process
   Improved support model including direct communication with apprentices via multiple media
   Improved flexibility for in-school attendance

The Ministry:
Clear articulation of first steps towards a comprehensive, modernized apprenticeship system, including:
Streamlined, flexible seat purchase process/systems
Transferring outreach and relations management from a supportive model for regional offices to the TDAs with respect to in-class training
Better monitoring of apprentice's progress, outcomes and completion
Comprehensive data to support budgeting, long term planning and policy alignment/development

TDAs (Including Union Facilities and Public Colleges):
Leverage the expertise of the colleges in maintaining relationships with apprentices throughout the entire educational pathway, as they do with PSE today
A minimum set of data to be released and shared among all stakeholders will need to be identified and agreed upon at the start of the project
Allow for sufficient preparation and assessment in academic readiness to support orientation and preparedness for retention and apprentice success management
Greater advocacy from high school counsellors to support the mission of increased engagement in the apprenticeship pathway
TDA IT teams will require that integration with all student information systems (SIS) is considered a part of the project

Sponsors and Employers:
Track status of apprentices and their completion of competencies and time (e.g. electronic logbook)
Improved scheduling and flexibility for in-school training periods will help small and medium size employers align their own workloads with the absence of an apprentice while they attend training
Trade-specific data for workforce management and forward planning
Better information in support systems (counsellors, advisors, etc.)
Marketing campaign on how to join the trades, and centralized place to find information
Streamline processes that make it easier for employers to sign up apprentices and get them on their way
Articulate what the entry points are and what is being proposed around them
Ease of access to apprenticeship-related data with tracking and reminders for their own apprentices

Counsellors and Influencers:
Clear, visible pathway through apprenticeship for guidance counsellors to articulate to students and their parents similar to their PSE experiences.
All PSE options (university, college, skilled trades) should be promoted and valued equally through high quality marketing materials and campaigns

### Apprenticeship Journey Framework

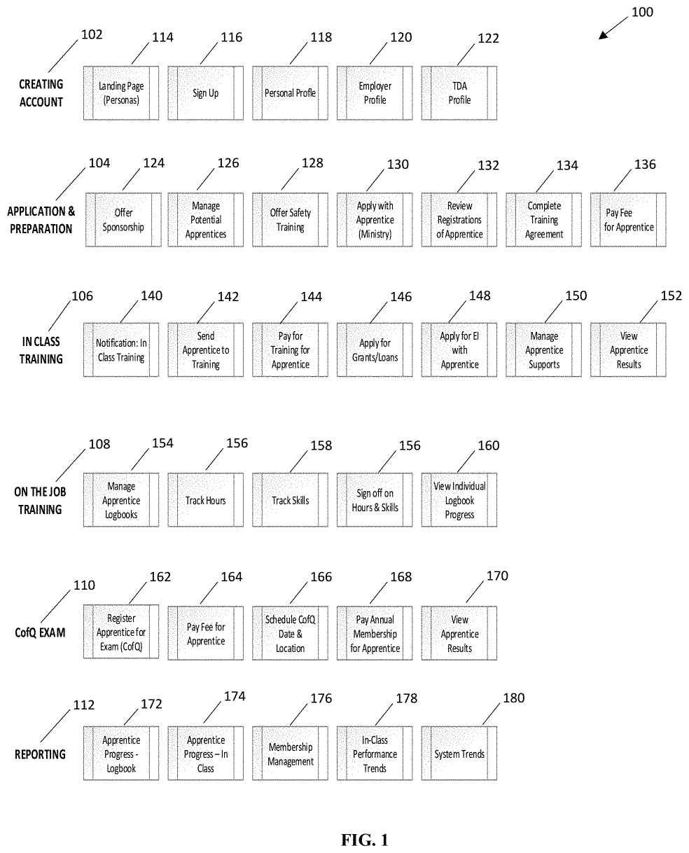

Building on consultation with stakeholders and personas across the apprenticeship ecosystem, key building blocks of the apprentice journey and establishing key screens for the apprentice, employer, training delivery agent, and ecosystem partner personas were identified. FIG. 1 is a model representing different stakeholder's journey through an apprenticeship system. The apprenticeship system 100 of FIG. 1 includes multiple phases, including “Creating Account” 102, “Application and Preparation” 104, “In Class Training” 106, “On the Job Training” 108, “Certificate of Qualification (CofQ) Exam” 110, and “Reporting” 112.

### Phase 1: Account Creation

In today's apprenticeship ecosystem, consistent, reliable information on trades careers can be challenging to find. To address these challenges, the system should provide:
An interactive, online guide with information for current apprentices, potential apprentices, guidance counsellors, and other influencers based on single, consistent sources of information and real-time data on trade availability.
The ability for potential apprentices to discover the various trades and pathways that are accessible to them for entry to the trades.
Potential for partnering and/or cross-linking with other organizations who work to engage young people in the skilled trades, such as unions, community partnerships, and Skills Ontario.

A gap also exists in the ability to promote available apprenticeship opportunities and connect ready and willing apprentices to them. An employer-apprentice matching system would facilitate this search, matching employers and apprentices together and providing transparency into skilled trades opportunities. Highlights of this feature could include:
The ability for prospective apprentices to view and connect with employers in their area.
The ability for employers to view listings of apprentices suitable for their opportunity.
Opportunity for employers and apprentices to receive notifications on new listings for both apprentices and employers.

Referring back to FIG. 1, in the “Creating Account” phase 102, the user will be deal with an initial “Landing Page” 114 or home screen. The user will also deal with “Sign Up” 116, “Personal Profile” 118, “Employer Profile” 120 and “TDA Profile” 122. The system will enable real-time employer and apprentice data sharing around the apprenticeship ecosystem 100.

### Phase 2: Registration (Application and Preparation)

The second phase involves registration, specifically the “Application and Preparation” 104 of the registration process. Activities in this phase include “Offer Sponsorship” 124, “Managing Potential Apprentices” 126, “Offer Safety Training” 128, “Applying with Apprentice” 130 which involves approval/sign-off from the ministry, “Review Registration of Apprentice” 132, “Completing the Training Agreement” 134, “Paying the Fee” 136, and finally “Registering as an Apprentice” 138 at an accredited institution.

Providing a single system for apprentice registration improves the experience by ensuring registrants are only required to provide their information one time, in one location. A single registration point also ensures that information stays up to date among apprentices, employers, the ministry, and TDAs. Features of a single registration system include:
Instead of registering in multiple locations (the ministry, TDA), apprentices are able to register on a single website, where they can add their personal information and employer information, and indicate what trade they wish to join.

Employers are able to submit an application to be approved as sponsors, and can also view and maintain information about their registered apprentices, journeypersons, and business.
According to their defined role, Ministry users are able to log into the website/mobile app to view existing apprentices and sponsors, approve apprentices who have applied or registered, approve RTAs, and approve and manage new sponsors.
Business rules agreed upon by all sides will determine what data is sent and when it is sent, so that information can be transmitted to stakeholders automatically at the appropriate time in the process.
Identity management rules enable viewing and receipt of information.
The system will allow an apprentice to update their personal information and sponsor information in one location, ensuring that their information is always current and shared with employers, unions, TDAs, and the Ministry.

### Phase 3: In-Class Training

Seat planning and management is another challenging element for training delivery agents, apprentices, and their employers, and would benefit from modernization. A new system for seat management would allow colleges and other TDAs to leverage their competencies in student relationship management to ensure that courses are adequately filled, and that apprentices are receiving the same level of service as their counterparts in other pathways of post-secondary education.

The activities associated with “In-Class Training” phase 106 can be seen in FIG. 1. These activities include “Notification for In Class Training” 140 to all stakeholders, “Send Apprentice to Training” 142, “Pay for Training for Apprentice” 144, “Applying for Grants/Loans” 146, “Applying for Employment Insurance (EI)” 148, “Manage Apprentice Supports” 150, and “View Apprentice Results” 152.

Features of an online system for seat management to handle in-class training would include:
Ability for TDAs to schedule classes based on appropriate allocations and data from the system on apprentice completion of required competencies.
Recommendations for appropriate instances of in-class training based on signed-off competencies in the digital logbook and TDA preferences.
Notifications sent to all stakeholders (TDAs, employers, apprentices) about the apprentice's readiness to move forward with training, registration and seat availability, and approvals from employers.
Early transmission of apprentice information to TDAs, enabling them to meet the challenge of providing classroom and support services to students within the constrained timelines of apprenticeship in-class training.
Integration with the ministry and the relevant federal agency (such as Employment & Social Development Canada), making it possible for apprentices to transmit their information to begin their Employment Insurance application.
Capability for TDAs to register apprentices for, and indicate completion of, pre-exam preparation courses and programs.
As an apprentice progresses through their courses, their progress and success is recorded in one system, allowing all stakeholders to see which levels and courses have been completed and any courses that were failed. As an apprentice returns to class, all stakeholders are aware of their progress and required courses.
Opportunities for support interventions as needed from TDAs and employers, or as requested by apprentices. Supports can flow to the apprentice more effectively, improving their ability to succeed in class.
Optionally, the system can allow for the collection and transmission of classroom fees to TDAs.

### Phase 4: On-the-Job Training (Personalized Logbook)

The next phase of the model of FIG. 1 involves “On the Job Training” phase 108, which includes the activities of “Managing Logbook” 154, “Tracking Hours” 156, “Tracking Skills” 158, “Sign off on Hours and Skills” 160, and “Viewing Logbook Progress” 160.

By building an electronic logbook, one can ensure that up-to-date information is always available to the Ministry and TDAs in making decisions about apprentices, seats, and trades. Having an electronic logbook is also beneficial for apprentices in that it simplifies the process for tracking their hours and skills and keeps it accessible through their devices. Features of the electronic logbook may include:
Apprentices are able to log into the website and native mobile app and see all of the competencies and hours required for their trade. Apprentices can record completion of competencies or time, and their employer can approve those competencies or hours.
As apprentices are working through on-the-job training, they are able to track progress towards their next in-class training, be notified of their eligibility for in-class training sessions, and be informed of the various sections that are available.
Throughout this process, the ministry and other stakeholders are able to track the progress of individual apprentices, as well as gather information on the performance of employers, and compare the success of on-the-job training across trades.
In the interest of keeping the apprentice engaged and working through their competencies or hours, reminders and notifications can be sent to them when they haven't completed or logged any inputs over a period of time.
Since many apprentices are mobile-first consumers who may own only a mobile device, text (SMS) notifications from the system will improve communications and ensure greater responsiveness among all system users.
The system will allow an apprentice to update their personal information and sponsor information in one location, ensuring that their information is always current. The application is also able to regularly notify the apprentice to confirm that the correct information is on file.

### Phase 5: Certification (CofQ Exam)

The next phase of the model of FIG. 1 involves certification or “Certificate of Qualification Exam” phase 110, which includes the activities of “Registering Apprentice for CofQ Exam” 162, “Pay Fee for Apprentice” 164, “Schedule Date and Location” 166, “Pay Annual Membership for Apprentice” 168, and “Viewing Logbook Results” 170.

Once an apprentice has completed their worksite competencies, worksite hours, and required in-class training, certification steps can also be handled in the system. This ensures that all validated information on the accomplishments of an apprentice are stored in a single location during the certification process. Features of a certification system may include:
A single location to validate an apprentice's courses, competencies, and hours, leveraging data from other areas of the system.
Ability to register for an exam sitting, if the apprentice is in a trade that requires a Certificate of Qualification examination.
Ability to apply for the Certificate of Apprenticeship certification, if the apprentice has worksite competencies, worksite hours, and required in-class training.
Real-time reporting for stakeholders on upcoming certifications and apprentice results, as well as aggregate data on the performance of apprentices, employers, specific competencies or courses against certification results.
Potential for electronic management of certifications to be extended to include other certifications required in the trades (such as First Aid, Work at Heights, Gas Ticket, etc.).

### Phase 6: Reporting

An apprenticeship system ensures that all data about the apprentice journey resides in a single location, allowing for real-time data exchange among stakeholders. Within the apprenticeship system, stakeholders will be able to obtain real-time reporting on:
Single sources of information on registered apprentices and journeypersons.
Progress of apprentices towards specific skills competencies and on-the-job training hours.
Progress and success of apprentices towards in-class courses.
Apprentices requiring interventions or additional supports in class or on the job.
Enrolment projections and capacity/demand planning for in-class training sessions, by trade and by TDA.
Upcoming certifications and apprentice certification results.
Information on the performance of employers, with the ability to analyze the success of on-the-job training across trades.
Aggregate data on the performance of apprentices, employers, and training agents.
Aggregate data on the performance of a specific trade, allowing for changes and enhancements in required skills and associated coursework.

A modernized system with a connected data model improves metrics and reports across the entire apprenticeship system to aid in strategic decision-making, enabling far-reaching efficiencies for the jurisdiction's education and work ecosystems. Referring to FIG. 1, the “Reporting” phase 112 include such activities as “Apprentice Progress—Logbook” 172, “Apprentice Progress—In Class” 174, “Membership Management” 176, “In-Class Performance Trends” 178, and “System Trends” 180.

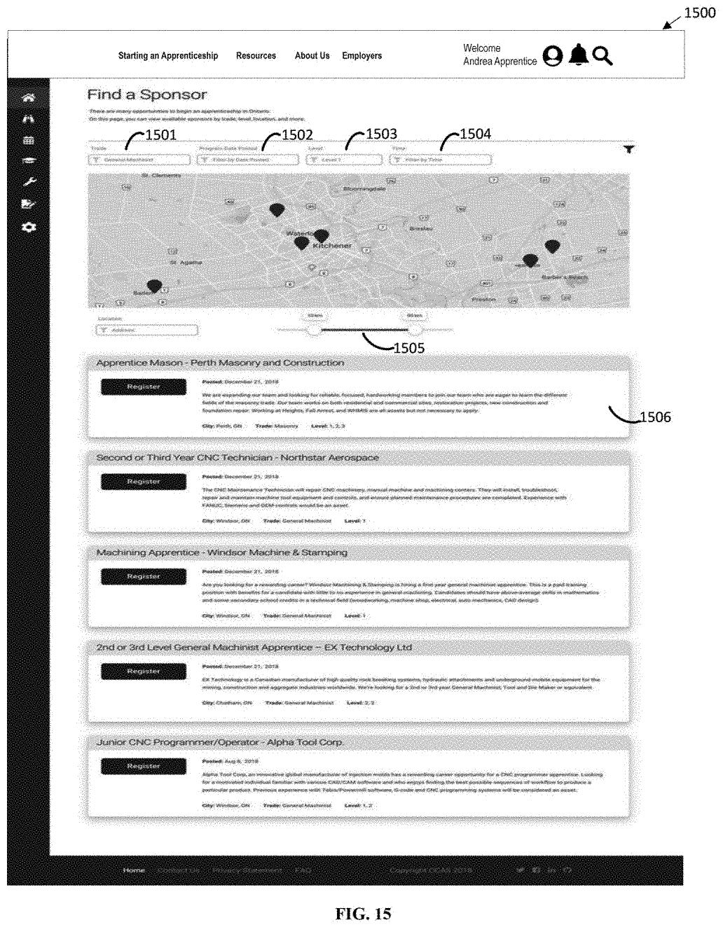

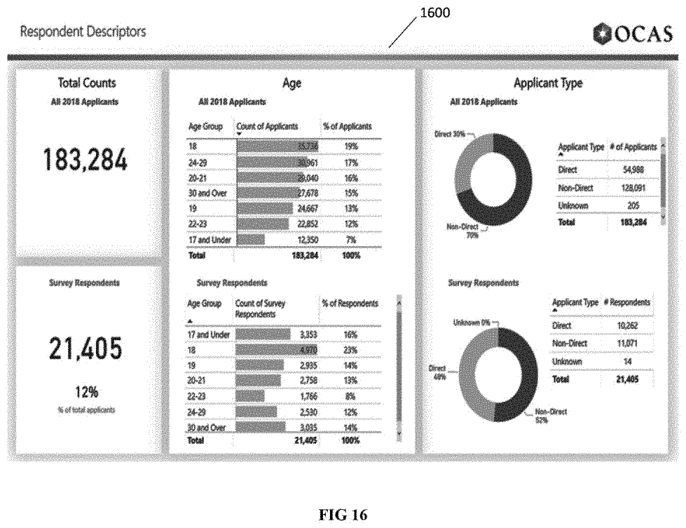

FIG. 16 is an example of reporting dashboard technology. Aggregate data about apprentices or employers can be developed and displayed as dashboards 1600 and be used to analyze system trends and perform business intelligence.

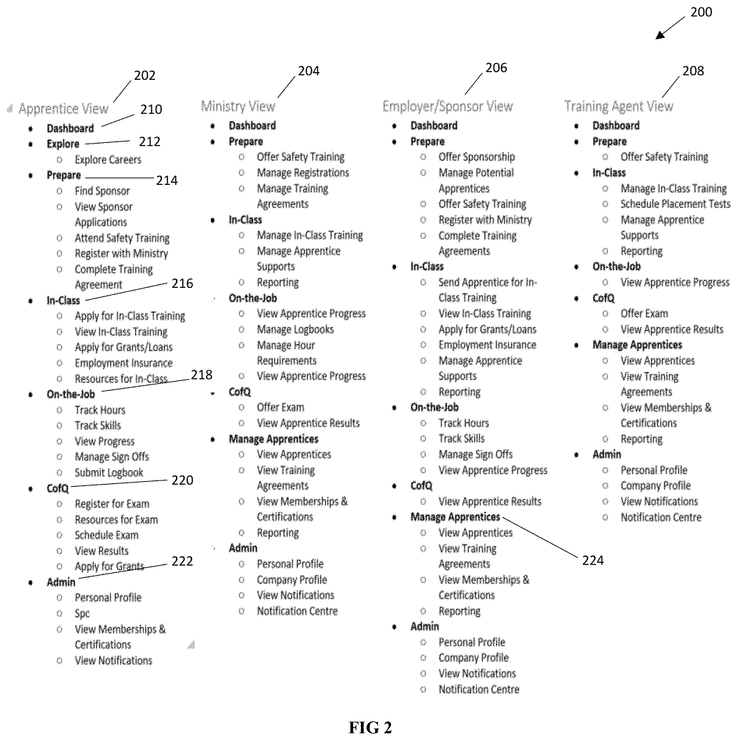

FIG. 2 illustrates a screen that shows functionality for each screen represented by different core persona or stakeholders. As seen in FIG. 2, the layout of the apprenticeship system 200 may be laid out by different views, including “Apprentice View” 202, “Ministry View” 204, “Employer/Sponsor View” 206, and “Training Agent View” 208.

Each view is further broken down into further activities (and further subsequent activities). As an example, the “Apprentice View” of FIG. 2, includes such activities as “Dashboard” 210, “Explore” 212, “Prepare” 214, “In-Class Training” 216, “On-the-Job Training” 218, “CofQ Exam” 220 and “Admin” 222.

Further, the other views of FIG. 2, including “Ministry View” 204, “Employer/Sponsor View” 206, and “Training Agent View” 208 includes such activities as “Dashboard”, “Prepare”, “In-Class Training”, “On-the-Job Training”, “CofQ Exam”, “Managing Apprentices” 224 and “Admin”.

The functions and relationships between the displayed database elements is further detailed and clarified in the following sections. Referring to the Safety Training elements of FIG. 2, A set of functions relating to Safety Training are required in all of the shown views into the Apprentice System. These functions can vary in scope depending on whether the view is offering or attending the safety training. Some apprentices need to attend safety training at the beginning of their journey as an apprentice. The system would include the ability to find a session, register for this training, and pay any associated fees.

Referring to the Ministry Registration and Ministry View portions of FIG. 2, as the overseer of the program, the Ministry Registration is an important step to ensure authenticity of the Apprentice System. Apprentices register in one place, adding personal information, employer information, and uploading supporting documents. Apprentices provide standard profile information, and then progressively complete their information on an as needed basis, contributing to their overall portfolio. Either the employer or the apprentice can begin the registration process.

In addition to core Ministry Registration functions, Apprentices can update their personal information and sponsor information in one location, ensuring that their information is always current. Apprentices will receive notifications to confirm that the correct information is on file. The System includes the ability to add customized fields, such as questions relating to additional qualifications for a specific trade.

Certain fields are dynamic, to ensure the correct information is captured. For example, if an apprentice specifies High School education, the options in the subsequent field update dynamically to narrow down the list to only the relevant options. The Apprentice System validates input fields information upon entry.

The Apprentice System allows users to save a partially completed application and return to finish it in the future. Apprentices and employers can log in to the System at any time to see the status of their application(s) and if there are any outstanding actions for them to complete. All updates/changes that happen in one area of the System are reflected in real-time across the other areas. In addition, the Apprentice System provides the ability for The Ministry to process and approve registrations, preparing a digital Registered Training Agreement.

Referring to the In-Class Training components of the Apprentice System shown in FIG. 2, Apprentices receive recommendations for appropriate instances of in-class training based on signed-off competencies in the digital logbook and TDA preferences. This in turn, allows apprentices to register well in advance, improving capacity planning for TDAs and workforce planning for employers. In addition, apprentices and employers can view upcoming classes to enable better workforce planning

The Apprentice System can optionally specify the requirement for employers to approve in-class registrations for their apprentices, if desired. Apprentices can search and filter by TDA, trade, location, level, status, timing, and type of class offered. Apprentices can also view full sessions and be added to the waitlist. Notifications are sent to all stakeholders (TDAs, employers, apprentices) about the apprentice's readiness to move forward with training, registration and seat availability, and approvals from employers. Apprentices register using existing profile information and pay online through the integrated payment system.

The Apprentice System allows for early transmission of apprentice information to TDAs, enabling providers to meet the challenge of providing classroom and support services to students within the constrained timelines of apprenticeship in-class training In addition, support interventions can be requested by apprentices at any time through the apprentice's journey and shared appropriately, improving their ability to succeed in class and on the job.

Referring to the Employment Insurance components of the Apprentice System shown in FIG. 2, participants are presented the option for the system to integrate with Employment and Social Development Canada, making it possible for apprentices to transmit their information to begin their Employment Insurance application.

Referring to the Hours and Skills Tracking components of the Apprentice System shown in FIG. 2, Apprentices can see all of the skills and hours required for their trade. Apprentices can explore the skill sets required for their trade, filtering on required/optional skills, and skills completed/incomplete. Apprentices can record completion of skills or hours by submitting to their sponsor. The Apprentice System offers just-in-time tracking, removing the need for apprentices to keep their paper logbook on hand to receive sign-offs or remain diligent in bringing the logbook to work to complete it. Information is stored digitally in the cloud, removing the risk of lost or misplaced logbooks. With previous systems, such as pen and paper or standalone electronic logbooks, when logbook is lost or destroyed, an apprentice can lose years of skills and hours tracking. In addition, In the interest of keeping the apprentice engaged and working through their skills or hours, reminders and notifications can be sent to them when they have not completed or logged any inputs over a period. The Apprentice System features a dual approval process, where both apprentice and sponsor sign off on the skill. The request can be initiated from either the apprentice or the sponsor. Specifically, sponsors/employers can view the progress of an individual apprentice, or a group of apprentices; Sponsors can approve signoffs for skills or hours individually or in bulk; Sponsors can initiate the signoff process for a skill as well as apprentices; and Sponsors will have access to reporting that identifies apprentices whose skill completion rate is lagging.

Referring to the Logbook components of the Apprentice System shown in FIG. 2, the logbook provides an at-a-glance view of the hours and skills that need to be tracked on the job. Once the logbook is complete, the apprentice can submit their logbook in the system, removing the paper processes. The ongoing, date-stamped, digital logbook provides a record of when skills have been signed off. This provides an incentive for sponsors to monitor and sign off on apprentice progress continuously, as opposed to signing off several skills at once based on memory.

Referring to the Grant components of the Apprentice System shown in FIG. 2, apprentices can find information about the financial incentives, grants, and loans available. Apprentices can apply for grants and loans related to apprenticeship within the same system, using the Apprentice's existing profile.

Referring to the Apprentice Supports components of the Apprentice System shown in FIG. 2, with all the elements of the apprentice's journey being facilitated in one place, there are many opportunities to provide additional supports to apprentices. Both the employer and the apprentice would have access to supports, including: resources about what to expect during in-class training, Ability to specify the need for additional accommodations, transmitting that information to TDAs, access to exam preparation courses, as well as insights & resources for test requirements, recurring topics, and test formats, access to a resource library for each specific trade, information on financial incentives, grants, and loans, and information on how to access employment insurance and what is required to start that process.

Referring to the Exams and Results components of the Apprentice System shown in FIG. 2, once an apprentice has completed their worksite competencies, worksite hours, and in-class training, the system can “unlock” the ability to register for an exam sitting. Apprentices can search for an available exam time, register, and pay any associated fees. The system will use machine learning to suggest an appropriate exam time. There will be additional information on the availability of exam preparation courses at the time of registration as well as insights & resources for test requirements, recurring topics, and test format (access to a resource library for each specific trade). Apprentices can specify the need for any additional accommodations (such as Accessibility Services) and this information will be sent automatically to the exam provider. Exam providers can manage their exam sessions and number of seats available, process waitlist requests and receive information about apprentices requiring additional accommodations. Exam providers can input results and release them to apprentices.

Referring to the Training Agreement components of the Apprentice System shown in FIG. 2, once both an apprentice and the employer have provided their registration information, the Ministry would process and approve registrations, preparing a digital Registered Training Agreement. This document could include digital signatures from both the apprentice and the employer.

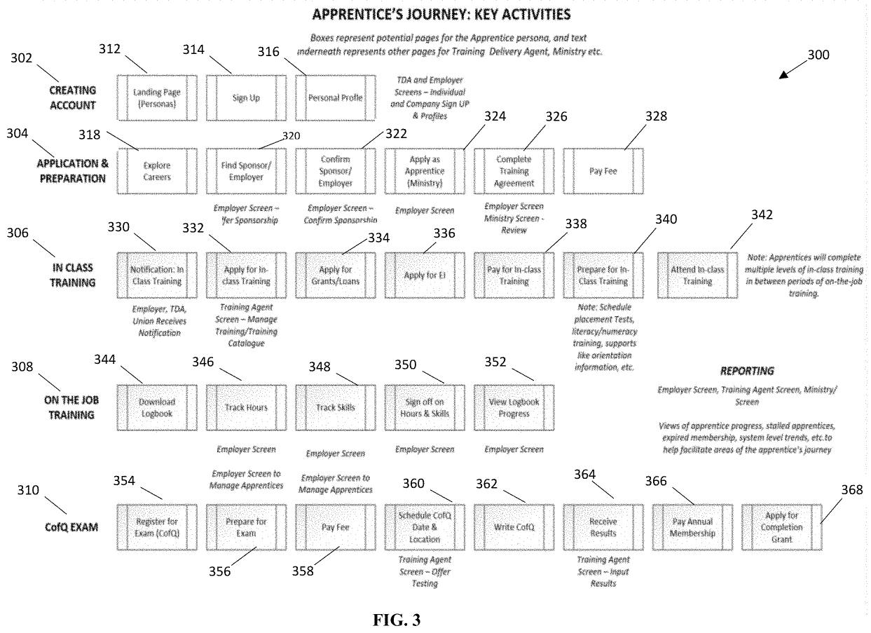

FIG. 3 is a model representing an apprentice's journey through an apprenticeship system 300. FIG. 3 illustrates such phases in the workflow including “Creating account” 302, “Application Preparation” 304, “In Class Training” 306, “On the Job Training” 308, and “Certificate of Qualification (CofQ) Exam” 310, all from the apprentice's perspective. The model of FIG. 3 demonstrates some of the challenges for each persona in the apprenticeship journey, particularly as they relate to the non-linear nature, and will serve as the basis for future discussion on identifying key needs for each stakeholder.

As seen in FIG. 3, the apprentice is involved in all the activities in the “Creating Account” phase 302 including dealing with an initial “Landing Page” 312 or home screen, dealing with “Sign Up” 314 and “Personal Profile” 316.

In the “Application & Preparation” phase 304, the apprentice is involved with the activities of “Explore Careers” 318, “Finding a Sponsor/Employer” 320, “Confirm Sponsor/Employer” 322, “Apply as Apprenticeship” 324, and “Completing the Training Agreement” 326, and “Pay Fee” 328.

In the “In Class Training” phase 306, the apprentice is involved with “Notification of In Class Training” 330,“Applying for In Class Training” 332., “Apply for Grants/Loans” 334, “Apply for EI” 336, “Pay for In-Class Training” 338, “Prepare for In-Class Training” 340, and “Attend In-Class Training” 342.

During the “On the Job Training” phase 308, the apprentice is involved with “Download Logbook” 344, “Track Hours” 346, “Track Skills” 348, “Sign off on Hours & Skills” 350, and “View Logbook Progress” 352.

Lastly, during the “CofQ Exam” phase 310, the apprentice is involved with “Register for Exam (CofQ)” 354, “Prepare for Exam” 356, “Pay Fee” 358, “Schedule CofQ Date & Location” 360, “Write CofQ” 362, “Receive Results” 364, “Pay Annual Memberships” 366 and “Apply for Completion Grant” 368.

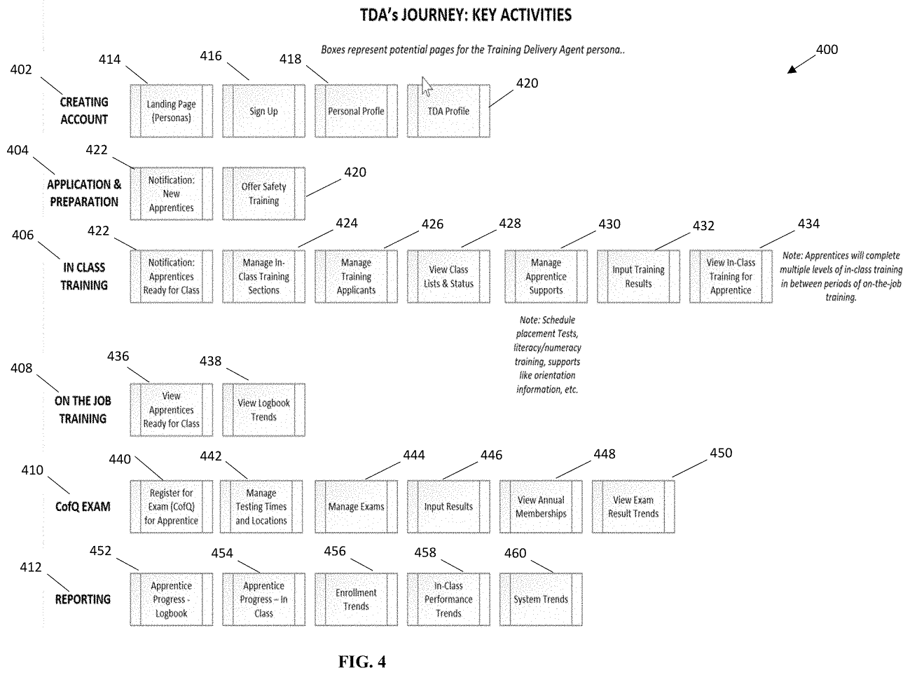

FIG. 4 is a flow diagram representing a training delivery agents (TDA)'s journey through an apprenticeship system 400. FIG. 4 illustrates such steps in the workflow including “Creating Account” 402, “Application Preparation” 404, “In Class Training” 406, “On the Job Training” 408, “CofQ Exam” 410 and “Reporting” 412, all from the TDA's perspective.

As seen in FIG. 4, the TDA is involved in all the activities in the “Creating Account” phase 402 including dealing with an initial “Landing Page” 414 or home screen, dealing with “Sign Up” 416, creating a “Personal Profile” 418, and creating a “TDA Profile” 420.

In the “Application & Preparation” phase 404, the TDA is involved with the activities of “Notification of New Apprentices” 412, and “Offer Safety Training” 420.

In the “In Class Training” phase 406, the TDA is involved activities related to “Notification of In Class Training” 422 and “Managing In Class Training Sessions” 424, “Manage Training Applications” 426, “View Class Lists & Status” 428, “Manage Apprentice Supports” 430, “Input Training Results” 432, and “View In-Class Training for Apprentice” 434.

During the “On the Job Training” phase 408, the TDA is involved with “View Apprenticeship Ready for Class” 436 and “View Logbook Trends” 438 activity. During the “CofQ Exam” phase 410, the TDA is involved with the activities of “Register for CofQ Exam for Apprentice” 440, “Managing Testing Times and Locations” 442, “Manage Exams” 444, “Input Results” 446, “View Annual Memberships” 448, and “View Exam Result Trends” 450.

During the “Reporting” phase 412, the TDA is involved with the activities of “Apprentice Progress—Logbook” 440, “Apprentice Progress—In Class” 454, “Enrollment Trends” 456, “In-Class Performance Trends” 458, and “System Trends” 460.

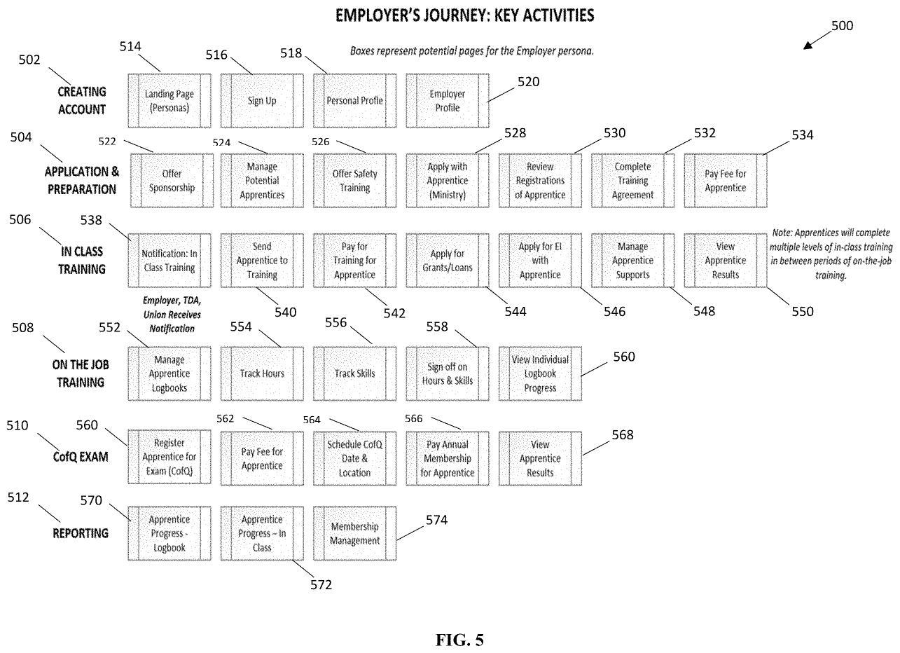

FIG. 5 is a flow diagram representing an employer's journey through an apprenticeship system 500. FIG. 5 illustrates such phases in the workflow including “Creating an account” 502, “Application Preparation” 504, “In Class Training” 506, “On the Job Training” 508, “Certificate of Qualification (CofQ) Exam” 510 and “Reporting” 512, all from the employer's perspective.

In the first “Creating Account” phase 502, the employer will be deal with an initial “Landing Page” 514 or home screen. The employer will also deal with “Sign Up” 516, creating a “Personal Profile” 518, and creating an “Employer Profile” 520.

The second phase involves the “Application and Preparation” 504. Activities in this phase include “Offer Sponsorship” 522, “Manage Potential Apprentices” 524, “Offer Safety Training” 526, “Applying as Apprentice” 528 which involves approval/sign-off from the ministry, “Review Registrations of Apprentice” 530, “Completing the Training Agreement” 532, and “Pay Fee for Apprentice” 534.

The third phase involves activities for “In Class Training” phase 506. Activities for this phase including providing “Notification for In Class Training” 538, “Send Apprentice to Training” 540, “Pay for Training for Apprentice” 542, “Apply for Grants/Loans” 544, “Apply for EI with Apprentices” 546, “Manage Apprentice Supports” 548, and “View Apprentice Results” 550.

The next phase of the model 500 of FIG. 5 involves “On the Job Training” phase 508, which includes the activities of “Manage Apprentice Logbook” 552, “Track Hours” 554, “Track Skills” 556, “Sign off on Hours and Skills” 558, and “Viewing Logbook Progress” 560.

During the “CofQ Exam” phase 510, the employer is involved with the activities of “Register for CofQ Exam for Apprentice” 560, “Pay Fee for Apprentice” 562, “Schedule CofQ Date & Location” 564, “Pay Annual Membership for Apprentice” 566, and “View Annual Memberships” 468.

The last phase of the model 500 is the “Reporting” phase 512. The TDA is involved with the activities of “Apprentice Progress—Logbook” 570, “Apprentice Progress—In Class” 572, and “Membership Management” 460.

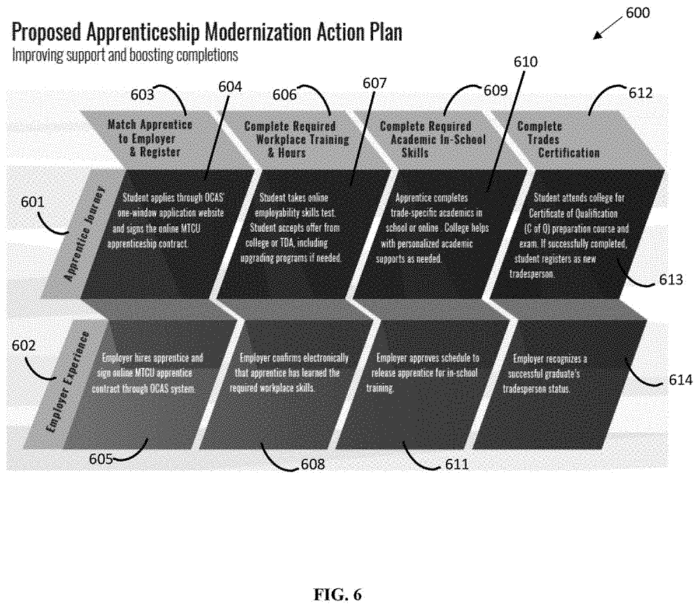

FIG. 6 is a flow diagram 600 representing an exemplary apprentice and employer workflow. FIG. 6 illustrates such steps in the workflow including matching apprentice to employer, complete required workplace training & hours, complete required academic in-school skills, and completing trade certification. FIG. 6 present the process workflow from both the apprentice's perspective 601 and the employer's perspective 602. While the steps are interdependent, they need not necessarily be completed in order; for example, the in-school component may be completed before the workplace training is completed, or both may happen concurrently. A workflow may also be envisioned in which no academic component is required for certification, or in which there is no preparation course or exam.

In the first stage 603 of the exemplary workflow, registration and matching of the apprentice to the employer, the apprenticeship applicant (or student) applies 604 through an application website (part of the apprenticeship system) and signs the government apprenticeship contract. The employer selects 605 and hires the apprentice, and signs the government employer apprenticeship contract through the apprenticeship system.

In the second stage 606 of the exemplary workflow, workplace training and required hours, the student works 607 for the employer for at least a specified number of hours, takes a skills test to verify that the work has resulted in learning the required skills, and accepts an offer from a college for the program or programs required for certification. The employer confirms 608 electronically that the apprentice has worked at least the minimum required number of hours, and that the apprentice has learned the required skills.

In the third stage 609 of the exemplary workflow, completion of academic in-school skills, the apprentice completes 610 trade-specific academic courses or programs in school or online, with additional supports (such as added or modified classes) being made available by the TDA as needed. The employer schedules 611 and approves the apprentice to allow them to attend classes.

In the fourth stage 612 of the exemplary workflow, completion of trades certification, the student attends 613 college or TDA for a qualification exam and optionally a preparation course. Upon completion of the exam with a passing grade, the student may register as a tradesperson. The employer may then recognize 614 the graduate as a tradesperson.

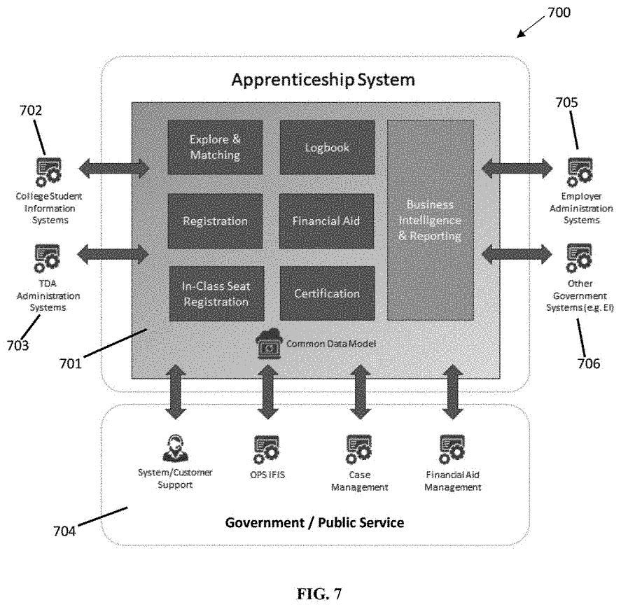

FIG. 7 is a block diagram illustrating an exemplary apprenticeship system. The apprenticeship system 700 as seen in FIG. 7 would be built on a common data model 701 so that information is shared across modules for all users, tasks, and business processes. This allows for real-time data exchange for a smoother and synchronized user experience for apprentices, employers, unions, and TDAs. The system will provide opportunities for integrations with other administrative systems to further this data sharing, facilitating the use of pre-existing systems investments by employers, unions, and TDAs. This minimizes adoption costs by all parties around the province, as long as existing systems facilitate standard data exchange protocols.

The apprenticeship system 700 as shown in FIG. 7 will implement a common data model 701 that all parts of the system will share. It will centralize the data and processes in one place to facilitate integration as well as the cross-system reporting. The data will be accessible and shared with key parts of the provincial public school system 702, as well as, the systems of other key partners in the support and delivery of an apprentice's training 703. Additionally, the data will be accessible to systems within the government/public service 704, to employer administration systems 705 and to other government systems such as Employment Insurance 706.

Some or all of the following technologies may be implemented in a modernized apprenticeship solution:
Modernized technology stack—reduces or eliminates manual processes via automated workflows, embedded business logic, and decision-treed algorithms
Digitization of paper processes—electronic document management, including RTAs and logbooks, to engage virtually across multiple devices and platforms, in real-time, without physical copies, and using electronic authentication.
Business process flexibility—enables apprentices to take courses by:
   employers indicating flexibility and exceptions
   opening apprentice applications in a region
   TDAs responding to regional needs, such as timing of significant infrastructure projects
Certification assessment—allows for streamlined and just-in-time testing, assessment, and credential integration.
Access to progression data—Track course-level outcomes, equivalencies and progression by trade, level, employer, or individual apprentice.
Notifications—in-app and text (SMS) notifications between all stakeholders will improve communications and ensure greater responsiveness among all system users. Notifications can provide updates on an apprentice's progress, signal next steps, and provide reminders to all appropriate stakeholders at each step of the process.
Single sign-on technology—users have one login to access the comprehensive system across multiple devices and platforms, managed within advanced security and data policies.
Connected data ecosystem—centralizes the data, rather than replicating it, ensuring speed, security, and cost containment.
Real-time data exchange—use of infrastructure with fast, distributed communication protocols to provide the ability to pass data seamlessly with existing employer, union, and TDA systems.
Security and data practices—ensure best-practice security, data storage, data transmission and data backup policies are implemented.
Privacy—the system will allow data permissions to be enforced based on role or institution type to allow universal access to a particular range of data, their data only, or data from their institution.
Responsive design—built with responsive, multi-platform modern design and development with the expectation that end users will be using a combination of computers, tablets and mobile phones.
Accessibility—may be built to compliance with Accessibility for Ontarians with Disabilities Act (AODA) level 1, and may meet or exceed the W3C Web Content Accessibility Guidelines (WCAG) 2.0 Level AA.
Reporting—available to appropriate stakeholders on apprentices (personal information, training progress, completion rates), TDAs (seats available, filled, attended, passed), sponsors (associated apprentices, success trends) based on security and privacy policies.
Business Intelligence—real-time metrics and analysis available to all stakeholders based on their areas of interest and permissions.
Ongoing investigation and validation—as needed throughout the project, we engage in surveys, benchmarking, business process analysis and other activities to identify new feedback to integrate and validate existing plans.

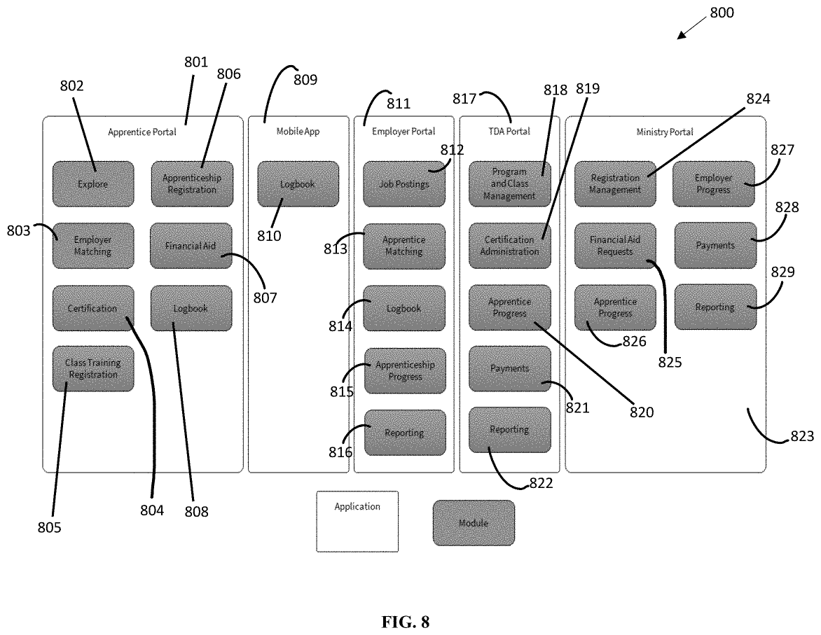

FIG. 8 is a block diagram illustrating components of an exemplary apprenticeship system 800. The Apprentice System will include distinct portals and apps for each principal persona. The portal will each deliver the needed capabilities within modules. All modules will interact with the shared database used within the system.

The Apprentice Portal 801 is the application accessed by the apprentice. It may be comprised of one or more of the following modules: an Explore module 802 which may implement a career and training guidance and exploration functionality; an Employer Matching module 803 which may implement employer searching, filtering and requirements matching functionality; a Certification module 804 which may implement certification qualification, tracking and guidance functionality; a Class Training Registration module 805 which may implement class searching, filtering, qualification and registration functionality; an Apprenticeship Registration module 806 which may implement qualification and registration functionality; a Financial Aid module 807 which may implement financial aid application, feedback, searching, qualification and notification functionality; and a Logbook module 808 which may implement hours and qualification tracking and verification functionality.

The Mobile App 809 is an application intended to be accessed from a mobile device, such as a mobile phone or tablet. It may be implemented as a browser application, may be written and compiled to run natively on a mobile device, or may be implemented in another fashion to be accessed from a mobile device. It primarily implements a Logbook module 810, whose functionality is similar to the Logbook module of the Apprentice Portal, though the mobile Logbook may only implement a subset of that module's functionality. The mobile logbook is enabled to accept qualification or hours entries, may be enabled to store these entries on a remote server, and may be enabled to track verification of these entries. The mobile logbook may be enabled to function in the absence of a cellular or broadband network, in which case the entries are cached and then later transmitted once the mobile device re-acquires a network connection. The mobile logbook may be enabled to use personal area networking (e.g. Bluetooth network) to communicate with another mobile device being used by an employer, to allow employer verification of logbook entries in the absence of a cellular or broadband network connection.

The Employer Portal 811 is the application accessed by an employer. It may be comprised of one or more of the following modules: a Job Postings module 812, which may implement job description editing, qualification entering, application viewing, application response and hiring functionality; an Apprentice Matching module 813 which may implement viewing of applicant profiles, searching of applicants, viewing of listings of qualified applicants and hiring functionality; a Logbook module 814 which may implement communication with apprentice logbooks, communication with a central server, viewing and verification of apprentice logbook entries, and notification of new entries; an Apprenticeship Progress module 815 which may implement viewing of the progress of an apprentice through the class, employment or qualification stages of the apprenticeship process; and a Reporting module 816 which may implement communication with any other module in the Employer Portal 811 to collect statistics or information, and generation and viewing of reports relating to job postings, apprentices, or any other statistic related to the apprenticeship system.

The TDA Portal 817 is the application accessed by a TDA (Training Delivery Agent, such as a school or independent educator). It may be comprised of one or more of the following modules: a Program and Class Management module 818 which may implement requirements analysis, seat management, program description, and scheduling functionality; a Certification Administration module 819 which may implement communication with a certification or accreditation system to administer the process of certifying an apprentice; an Apprentice Progress module 820 which may implement viewing of the progress of an apprentice through the class, employment or qualification stages of the apprenticeship process, and which may implement tracking of needs for training for apprentices; a Payments module 821 which may implement acceptance and tracking of payments by apprentices for training, notifications of late or outstanding payments, and communication with the Program and Class Management module 818 to enable seat registration when payments have been made or arranged; and a Reporting module 822 which may implement communication with any other module in the TDA Portal to collect statistics or information, and generation and viewing of reports relating to training, apprentices, or any other statistic related to the apprenticeship system.

The Ministry Portal 823 is the application accessed by users in the relevant Ministry (such as Labour or Education), or a similar governmental organization tasked with organizing or supervising the apprenticeship process. It may be comprised of one or more of the following modules: a Registration Management module 824 which may implement the acceptance of apprenticeship program applications, verification of applicant qualifications, verification of available seats for applicant training, and sending of acceptance or rejection notices; a Financial Aid Requests module 825 which may implement the acceptance of financial aid applications, the verification of financial aid eligibility, and the sending of acceptance or rejection notices; an Apprenticeship Progress module 826 which may implement viewing of the progress of an apprentice through the class, employment or qualification stages of the apprenticeship process; an Employer Progress module 827 which may implement viewing and tracking of an employer's progress through the apprenticeship process; a Payments module 828 which may implement viewing and tracking of payments made throughout the apprenticeship system, such as payments made by applicants to the Ministry, payments made by applicants to TDAs, or payments made by TDAs or employers to the Ministry; and a Reporting module 829 which may implement communication with any other module in the Ministry Portal 823 to collect statistics or information, and generation and viewing of reports relating to training, apprentices, or any other statistic related to the apprenticeship system.

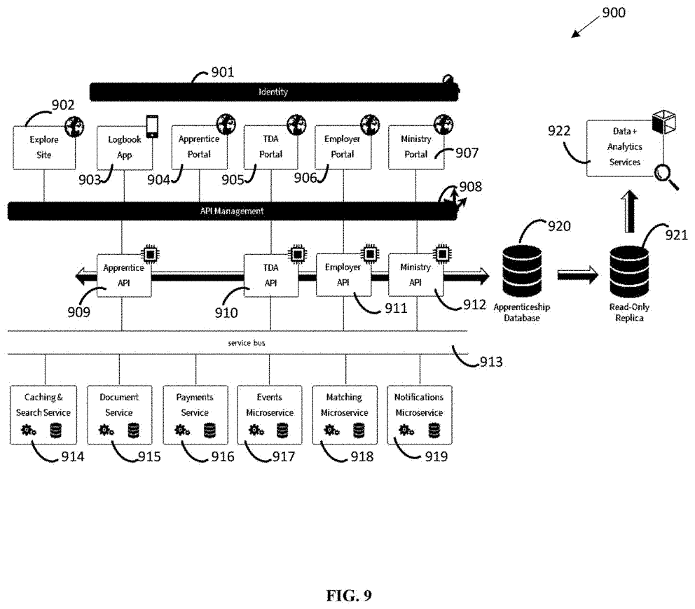

FIG. 9 is a block diagram illustrating structural components of an exemplary apprenticeship system 900. The Apprenticeship System will be made using a modern solution architecture. Applications will be composed using a mesh of APIs and microservices, all of which will be connected using a service bus. All portals and APIs will be secured with OCAS' core Identity Service 901, or an equivalent system. An API management gateway will protect the API tier from threat of exposure of private data and ensure availability. Data analytics reports may be generated from a replica of the database to ensure high performance of the system.

An exemplary apprenticeship system may be comprised of one or more of the following elements: an Identity module which provides user authentication and grants a user access rights to certain data sets on one or more portals depending on that user's stored access credentials; an Explore Site module 902 which implements career and training guidance and exploration functionality; a Logbook App 903 which primarily implements a Logbook module as noted previously; Apprentice Portal 904, TDA Portal 905, Employer Portal 906 and Ministry Portal 907 application systems which implement the respective applications as noted previously; an API Management subsystem 908 which allows communication between various modules as shown, on a secured and authenticated basis where deemed necessary, and which implements an Apprentice API 909, a TDA API 910, an Employer API 911 and a Ministry API 912; a Caching & Search Service 914 which may implement caching of data and allow for centralized searching of data; a Document service 915 which may store documents in a secure centralized subsystem and allow for authenticated, secure access to the documents; a Payments service 916 which may enable payment transactions and implement queryable payment tracking and verification; an Events Microservice 917 which may implement event tracking and querying; a Matching Microservice 918 which may implement matching between selected entities; a Notifications Microservice 919 which may implement registration for and sending of notifications across the system; a service bus 913 which may connect the services to the API Management subsystem 908; an Apprenticeship Database 920 which may securely store and retrieve some or all of the data associated with the Apprenticeship System 900; a Read-Only Replica 921 which is a regularly-updated read-only copy of some or all of the Apprenticeship System 900; and a Data+Analytics Service 922 which allows for analysis of the data stored in the Apprenticeship System 900.

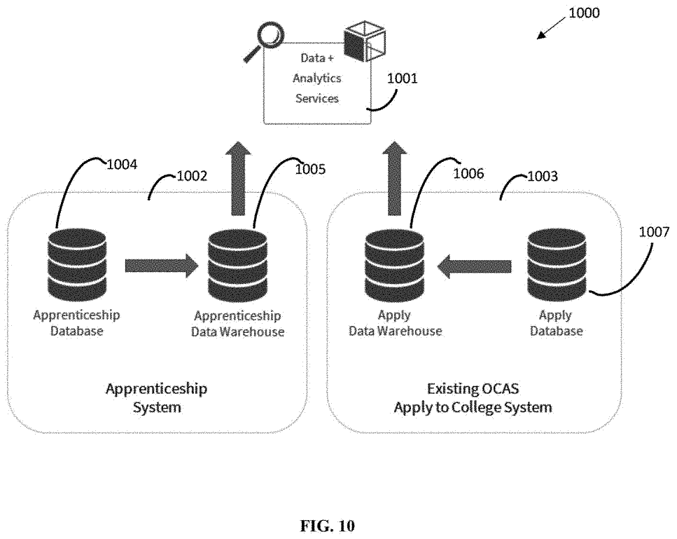

FIG. 10 is a block diagram 1000 illustrating an interfacing between an exemplary apprenticeship system 1002 and an exemplary college application system 1003, both feeding data into a Data+Analytics Services module 1001. A core value proposition of the Apprenticeship system is being able to provide analytics across the existing Ontario Colleges application system as well as the apprenticeship system. This will provide deep and broad insights into the pathways students take in the path to become an apprentice and a tradesperson. Analytics and research tools will be able to use both systems as data sources and correlate student information (depersonalized) for complete journey details.

The Apprenticeship System 1002 stores its data in the Apprenticeship Database 1004. A regular copy of some or all of this data is made into the Apprenticeship Data Warehouse 1005 (also referred to elsewhere as the Read-Only Replica 921 of the Apprenticeship Database 920). The College Application System's 1003 Apply Database 1007, which stores some or all of the data in the College Application System 1003, is copied regularly, in all or in part, into the Apply Data Warehouse 1006. The data in the two Data Warehouses may be accessed by the Data+Analytics Services 1001 through an API mechanism. The Data+Analytics Services 1001 may analyze statistics, trends, demographic information, or any other statistic or derived measure made available through the Apprenticeship 1002 or Apply To College 1003 Systems.

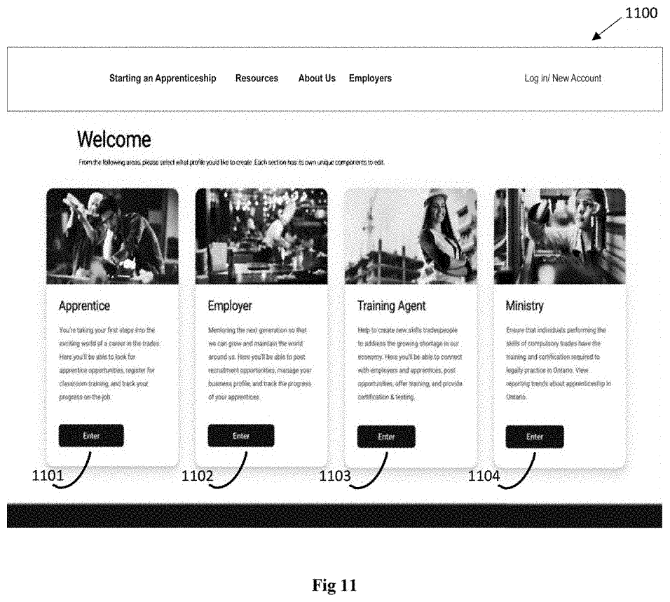

FIGS. 11 to 16 are screenshots illustrating exemplary home screens for the apprenticeship system. These figures illustrate:
Accessing the Apprenticeship system, signing in, and creating a profile
Finding a sponsor/employer
Applying for in-class training
Registering for a Certificate of Qualification (CofQ) exam
Managing in-class training from the perspective of a TDA

FIG. 11 illustrates the login/home screen 1100 of the apprenticeship system. This screen allows the user to select an identity for login (apprentice 1101, employer 1102, TDA 1103 or government employee 1104).

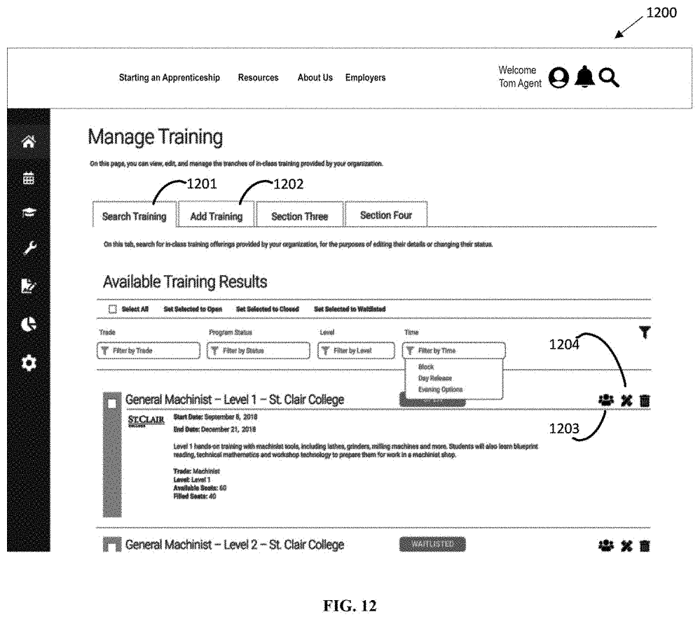

FIG. 12 illustrates the Manage Training screen 1200 that demonstrates how a training agent (TDA) would offer tranches of training, manage enrollment, and view participants. The screen allows for searching of training offerings with the Search Training tab 1201, creation of new offerings with the Add Training tab 1202, editing of offering descriptions 1204, and changing of offering statuses 1203.

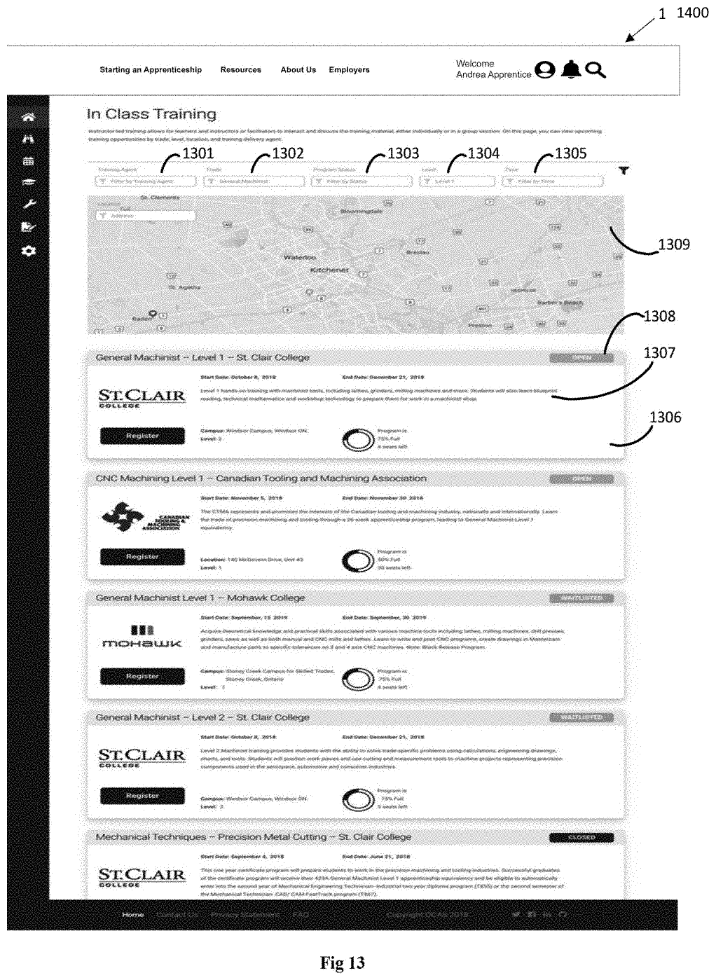

FIG. 13 illustrates a screen 1300 that shows how an apprentice could search for in-class training sections, as well as some of the notifications that could be present in the system. This exemplary search screen is enabled to allow for the apprentice to search for programs by TDA 1301, trade 1302, program status 1303, level 1304 and time 1305. Other contemplated search criteria may include instructor name, class length, facility accessibility criteria, or any other search criteria which may be relevant. Also illustrated is that the screen shows example search results 1306 from the search process, including providing offering details 1307 and offering status 1308, and showing a map 1309 with the training locations.

As part of the search process, apprentices receive recommendations for appropriate instances of in-class training based on signed-off competencies in the digital logbook and TDA preferences. The system allows apprentices to register well in advance, improving capacity planning for TDAs and workforce planning for employers. Apprentices and employers can view upcoming classes to enable better workforce planning. The system can optionally specify the requirement for employers to approve in-class registrations for their apprentices, if desired.

Apprentices can search and filter by TDA, trade, location, level, status, timing, and type of class offered. Apprentices can view full sessions and be added to the waitlist. Notifications are sent to all stakeholders (TDAs, employers, apprentices) about the apprentice's readiness to move forward with training, registration and seat availability, and approvals from employers. Apprentices register using existing profile information, pay online through the integrated payment system, and optionally, the system can allow for transmission of classroom fees directly to TDAs.

The system is enabled to provide early transmission of apprentice information to TDAs enabling providers to meet the challenge of providing classroom and support services to students within the constrained timelines of apprenticeship in-class training. Support interventions can be requested by apprentices at any time through the apprentice's journey and shared appropriately, improving their ability to succeed in class and on the job.

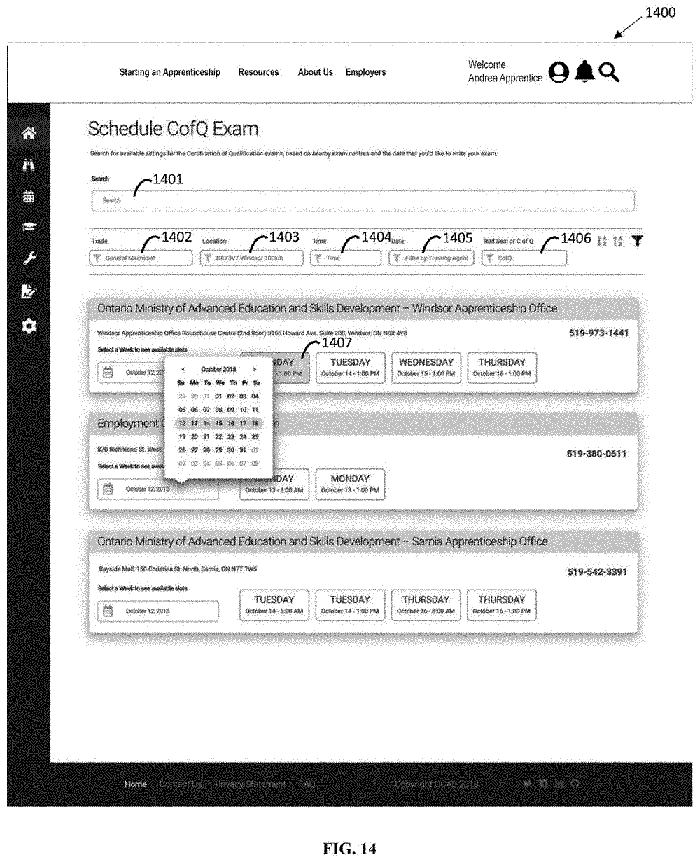

FIG. 14 illustrates a screen 1400 that shows the apprentice's view of scheduling of the Certification of Qualification (CofQ) exam. The system validates an apprentice's courses, competencies, and hours, leveraging data from other areas of the system, and allows for booking of exams booking only once requirements have been met. Apprentices can search 1401 and filter exam availability by trade 1402, location 1403, time 1404, date 1405, and type of exam 1406.

The system is enabled to allow apprentices to select a date and time 1407, use their existing profile to register, and pay for their exam through the integrated payment system. The system may include additional information on the availability of exam preparation courses at the time of registration as well as insights & resources for test requirements, recurring topics, and test format (access to a resource library for each specific trade).

During registration, the system is enabled to allow apprentices to specify the need for any additional accommodations (such as Accessibility Services) and that information will be sent automatically to the exam provider. Apprentices receive a confirmation email and relevant notification as the exam arrives. Notification of a pending exam can be sent to the TDA, the apprentice, the Ministry and the sponsoring employer. As an optional, value-add service, the system may integrate with a third-party exam management system to display schedules.

An embodiment of the system may enable the system to allow apprentices to search for, and register for exams. Invigilation services may be provided by the operator of the system or one of their business partners. This innovative, automated approach to exam registration along with a vast network of invigilation partners allows apprentices to remain in their community when scheduling, preparing for, and writing their exams.

FIG. 15 illustrates a screen 1500 that shows how an apprentice could view employers that are looking for apprentices. The screen is enabled to allow the apprentice to search for a sponsor (employer) through various criteria, filtering the sponsors by trade 1501, program date 1502, level 1503, time 1504 and proximity to a given location 1505. The sample screen shown also shows the results 1506 of the search.

FIG. 16 is an example of reporting dashboard technology. Aggregate data about apprentices or employers can be developed, as well as dashboards 1600 to outline system trends. The data may be viewed by anyone with appropriate credentials, as determined by the setup of the system. Aggregation and display of this data may be performed by the Data+Analytics Services module.

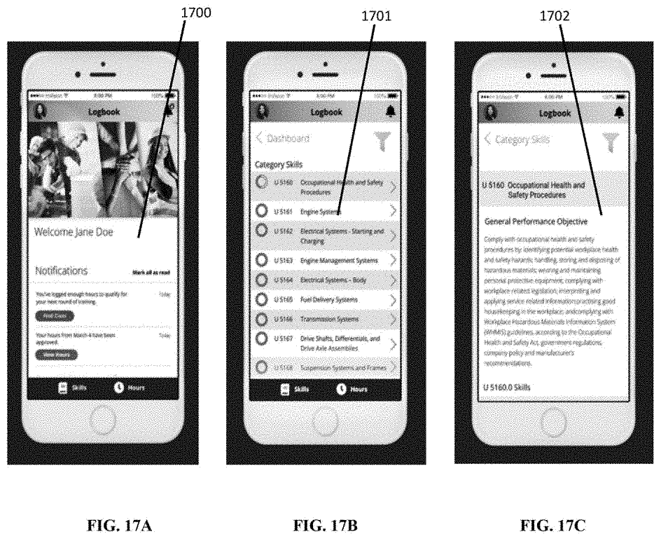

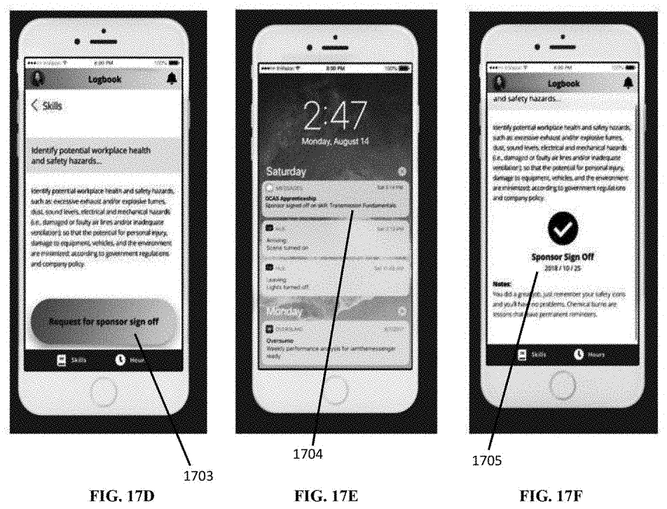

FIGS. 17A to 17F are diagrams illustrating exemplary screenshots of a digital logbook application. FIGS. 17A to 17F demonstrate how an apprentice from a single trade would log their skills and competencies on a mobile phone or tablet, how an employer would approve those skills, and how both the apprentice and employer could view overall progress towards completion. These screenshots also include examples of notifications among the apprentice, training delivery agent, and employer.

FIGS. 17A to 17C illustrate initial screens of the Logbook application. From left to right, these screens show the dashboard 1700 of the mobile app (FIG. 17A); the list of skills categories 1701 of a logbook (FIG. 17B), and the landing page 1702 for the first skill category (FIG. 17C).

FIGS. 17D to 17F illustrates further screens of the Logbook application. From left to right, these screens show where an apprentice would request sign-off 1703 on a skill (FIG. 17D); an SMS notification 1704 indicating their employer approved (FIG. 17E), and the resulting approval 1705 within the mobile app (FIG. 17F).

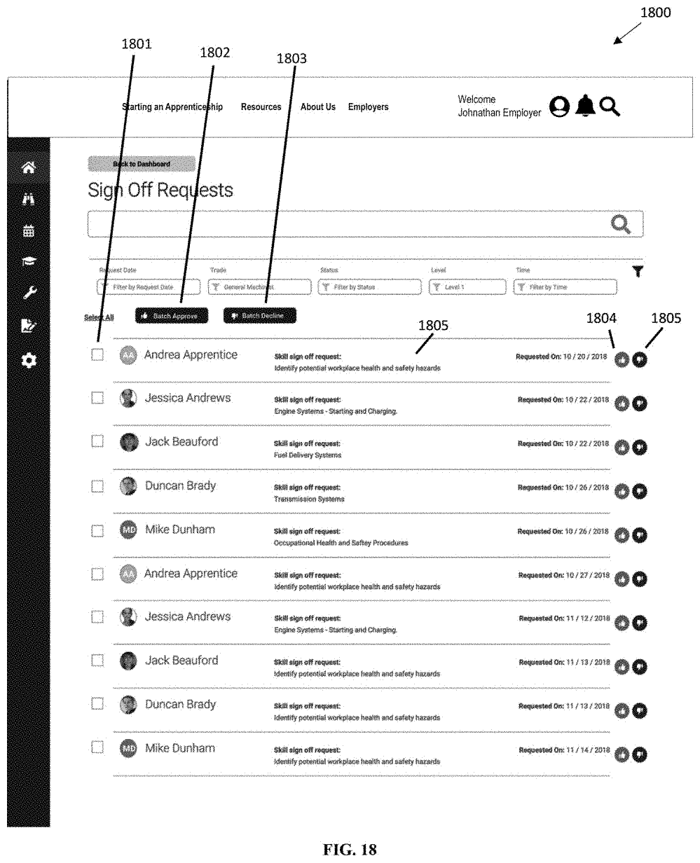

FIG. 18 illustrates a screen 1800 showing how an employer might approve their apprentice's skill sign-offs 1806 individually or in bulk. Bulk sign-off is accomplished through selecting some or all of the skill requests on the left 1801 and selecting Batch Approve 1802 or Batch Decline 1803. Additionally, skill sign off requests may be individually approved 1804 or declined 1805 with the indicated controls.

### Viewing and Approving Completed Skills

In further embodiments, the apprenticeship system may include the further features and embodiment as described below. In one embodiment of the system, apprentices are able to log into the website and native mobile app and see all of the competencies and hours required for their trade. Apprentices can explore the skill sets required for their level, filtering on required/optional skills, and skills completed/incomplete. Apprentices can record completion of competencies or time by submitting to their sponsor.

In one aspect of this embodiment, just-in-time tracking removes the need for apprentices to keep their paper logbook on hand to receive sign-offs or remain diligent in bringing the logbook to work to complete it. An optional offline capability allows for this aspect of the system to be used at remote job sites.

In one aspect of this embodiment, information is stored digitally in the cloud, removing the risk of lost or misplaced logbooks. Currently, when a logbook is lost or destroyed, an apprentice can lose years of skills tracking.

In one aspect of this embodiment, in the interest of keeping the apprentice engaged and working through their competencies or hours, reminders and notifications can be sent to them when they have not completed or logged any inputs over a period. The system may include the option for Short Messaging System (SMS) reminders and notifications to ensure mobile-first consumers and those who may own only a mobile device are able to keep up-to-date with their tracking.

In one aspect of this embodiment, a dual approval process is implemented, meaning that both apprentice and sponsor sign off on a skill. The request to sign off can be initiated from either the apprentice or the sponsor.

In one aspect of this embodiment, the sponsor's view may show the progress of an individual apprentice, or of a group of apprentices. Sponsors can approve signoffs for competencies or hours individually or in bulk. Sponsors can initiate the signoff process for a skill as well as apprentices. Sponsors will have access to reporting that identifies apprentices whose skill completion rate is lagging.

The system is enabled to allow the Ministry and other stakeholders to track the progress of individual apprentices, as well as gather information on the performance of employers, and compare the success of on-the-job training across trades. For apprentices who switch sponsors, signoffs from the previous employer can be carried over and remain validated. For apprentices switching trades, the system will offer the flexibility to carry over completed skills or skill sets, based on an approved transfer pathway from the Ministry.

### Classes and Class Schedules

In one embodiment, the system has the ability to create individual class and exam entities, as well as create these in bulk. The system is enabled to allow TDAs to schedule classes based on appropriate allocations and data from the system on apprentice completion of required competencies.

The system is enabled to integrate with a third-party exam management system to configure and display exam schedules. The system can accommodate all types of class registration, including pre-exam preparation courses and programs. Programs include similar attributes to classes, such as start dates, type of program, location (college and campus), availability, and additional information.

There may be multiple benefits to creating individual classes and class schedules, including:
Allow for easier matching of employers with potential apprentices
Consolidate information to facilitate a single point of application and a common data source to support all stakeholders in the apprenticeship system
Streamline the path and actions for apprentices and stakeholders to reduce duplication and multiple points of registration
Deliver a single common apprentice record to be shared electronically across multiple stakeholders
Use mobile technology to improve and modernize the competency-based trade logbook experience and provide real-time tracking of on-the-job training
Provide accurate data for the Ministry and TDAs with regard to in-class training demand, for improved seat plan allocation and budget planning
Transfer the responsibility of communication and engagement to the TDAs/colleges, allowing for earlier and more frequent contact
Allow for internal management of waitlists
Improve metrics and reports across the entire apprenticeship system, aiding in strategic decision-making and enabling far-reaching efficiencies for the jurisdiction's education and work ecosystem

### Client-Facing Functions of Digital Portal

In further embodiment, the apprenticeship system may include further client facing functionalities for a digital portal. The skilled trades and apprenticeship digital portal is anticipated to support the following high-level client-facing functions including:
Registration: Apprentices and sponsors can apply and register for apprenticeship training, including payment of fees and e-signing of training agreements.
On-the-job training: Apprentices can track skills they've learned on the job, and sponsors can approve skills that have been completed.
In-class training: Apprentices can search, register and pay for in-class training, at a Training Delivery Agent of their choosing.
Tracking progress: Apprentices and their sponsors can see where they are in their apprenticeship journey, including which activities have been completed and what is left to do.
Financial incentives: Apprentices and sponsors can view and apply for financial incentives, such as grants and bonuses.
Completion: Apprentices can complete their apprenticeship, with the option to receive an e-certificate and/or printed certificate.
Exams: Clients can register and pay for exams and view results.
Certification renewal: Journeypersons can renew and pay for certification.
Communication: Clients can receive electronic communication and automated notifications.

### Membership and Certification Management

In further embodiment, the apprenticeship system may be enabled to provide the following capabilities:
Ability to create electronic certificates, incorporating information from the apprentice's profile, such as their name, trade, certification expiry date, etc.
   Certificates can incorporate uniquely-generated certificate number and/or unique apprenticeship identifier (including but not limited to Social Security Number/Social Insurance number, a unique application number, a student number, or a unique function generated at least in part from personal information provided by the applicant).
   Unique identifier can be used to validate the status of an individual's certification or membership in publicly or privately available membership systems.
   The system could query associated systems that track enforcement actions to verify the standing of the apprentice or journeyperson to ensure that they are in good standing before processing renewals of any certifications.
Automated reminder emails as memberships or certifications are expiring
Pay associated membership fees using integrated payment system
Creation of a publicly or privately available membership system where information about the certification status of an apprentice or journeypersons can be searched.
Manage related certifications or memberships related to specific trades.

In a further embodiment, a method for processing apprenticeship credentials is disclosed. This method comprises the steps of creating an apprenticeship identifier that uniquely identifies a student; creating a database that uses the apprentice identifier as an index to store data records associated with that apprentice; creating a plurality of portals that allow for stakeholders in the apprentice data records to have access to view to a plurality of controlled subsets of the apprentice data records; providing a mechanism for at least one of the portals to update the data records associated with the apprentice; and providing updates to each of the portals' data records view when any of the apprentice data records are updated. The processing apprenticeship method includes one or more portals such as an apprentice portal, a Ministry portal, an Employer portal, a Sponsor portal, and a Training Delivery Agent (TDA) portal.

The aforementioned processing apprenticeship method also includes index identifier which includes a Social Security Number, a unique application number, a student number, or a unique function generated at least in part from personal information provided by the applicant.

In a further embodiment, the apprenticeship system includes a computer server for processing apprenticeship credentials. The computer server includes an apprenticeship identifier that uniquely identifies a student; a database that uses the apprentice identifier as an index to store data records associated with that apprentice; a plurality of portals that allow for stakeholders in the apprentice data records to have access to view a plurality of controlled subsets of the apprentice data records; a mechanism for at least one of the portals to update the data records associated with the apprentice; a mechanism for calculating and displaying an indication of the level of credential that the apprentice has met; and an indication that the regulatory agency has access to interrogate the apprenticeship credentials. The indication of the level of credential can be accessed by at least one of the apprentice, the employer, and the training agent. The training agent access is further restricted to a list of training agents selected by the apprentice.

In yet a further embodiment, a method of predicting whether the capacity of apprenticeship training is adequate. This method comprises creating a database of apprentices enrolled in apprenticeship programs in a geographic region; acquiring information regarding the training requirements for each of the apprenticeship programs in which the apprentices are enrolled; identifying the number of apprentices that have met the prerequisites for a specific training program; identifying the number of apprentices that have greater than a threshold probability of completing the pre-requisites before the training program is offered; relaying the information regarding the number of apprentices to at least one Training Agent; and identifying if the training capacity in any geographic region is adequate to train all of the probably qualifying apprentices.

In this method, the comparison is made for a plurality of apprenticeship programs with a common training program. In this method, the threshold probability of completing the pre-requisites is adjustable based on at least one factor. Furthermore, in this method, at least one factor is chosen from a list including past pre-requisite training completion for each individual apprentice, historical pre-requisite completion rates for similar apprentices, seasonal pre-requisite completion rates, and economic environment.

In yet a further embodiment, an electronic logbook application comprising a display means for creating and displaying apprentice data records; a communication means for communicating apprentice data to and from the logbook; a memory for storing intermediate values of apprentice data; a mechanism to authenticate the user of the logbook as an apprentice; a mechanism to associate the identification of the apprentice into the records updated or modified from the logbook; and a method of updating the records of a central server with the information entered in the electronic logbook. A central server can be architected from distributed components that operate as a central point of authority, such as a distributed processing or a cloud computing platform.

In a further embodiment, the electronic logbook contains details of a work record required for the completion of an apprenticeship. The electronic logbook also has a validation mechanism for a supervisor to authenticate that the hours were worked and for the supervisor to authenticate that task were successfully completed. The electronic logbook also has validation mechanism to authenticate authorized terminal registered to the supervisor.

The electronic logbook may also accept authenticated validations from a gesture or a code entered on the electronic logbook by the supervisor. The validation mechanism may occur via a Bluetooth or local network connection between an authorized supervisor terminal and the electronic logbook. The electronic logbook stores the work record and validation for later transmission to a central server. The electronic logbook is implemented as an application on a mobile phone, an electronic tablet or a mobile computing device.

In a further embodiment, a system for scheduling remedial training requirements in an electronic logbook is contemplated. The system comprising a display means for creating and displaying apprentice data records; a communication means for communicating apprentice data to and from the logbook; a memory for storing intermediate values of apprentice data; a mechanism to authenticate the user of the logbook as an apprentice; a mechanism to identify the criteria for successful completion of required apprentice work elements; a mechanism to select one or more remedial training skills from a list of skills when one or more of the criteria is not met; a mechanism for attaching the one or more selections to the apprentice training record; and a mechanism for updating the apprentice training record at a central server. Remedial training requirements may be requirements to revalidate the successful completion of on the job skills, or may include specific courses provided by a Training Agent.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, FORTRAN, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made.

Although various embodiments have been described as having particular features, concepts, and/or combinations of components, other embodiments are possible having any combination or sub-combination of any features, concepts, and/or components from any of the embodiments described herein. The specific configurations of the various components can also be varied. For example, the specific size, specific shape, and/or specific configuration of the various components and/or various inputs or outputs can be different from the embodiments shown, while still providing the functions as described herein. The size, shape, and/or configuration of the various components can be specifically selected for a desired or intended usage.

Where methods and/or events described above indicate certain events and/or procedures occurring in certain order, the ordering of certain events and/or procedures may be modified and that such modifications are in accordance with accepted and/or desired variations of the specific embodiments. Additionally, certain events and/or procedures may be performed concurrently in a parallel process when possible, as well as performed sequentially as described above. Certain steps may be partially completed or may be omitted before proceeding to subsequent steps.

1. A method for processing apprenticeship credentials comprising the steps of:
creating an apprenticeship identifier that uniquely identifies a student;
creating a database that uses the apprentice identifier as an index to store data records associated with that apprentice;
creating a plurality of portals that allow for stakeholders in the apprentice data records to have access to view to a plurality of controlled subsets of the apprentice data records;
providing a mechanism for at least one of the portals to update the data records associated with the apprentice; and
providing updates to each of the portals' data records view when any of the apprentice data records are updated.

2. The method of claim 1 whereby the index identifier is one of a Social Security Number, a Social Insurance Number, a number serving substantially the same purpose as a Social Security Number, a unique application number, a student number, or a unique function generated at least in part from personal information provided by the applicant.

3. The method of claim 1 wherein the portal is selected from a list comprising an apprentice portal, a Ministry portal, an Employer portal, a Sponsor portal, and a Training Delivery Agent (TDA) portal.

4. The method of claim 3 wherein the apprentice portal can modify or access items from a list containing at least one of an email address, home address, phone number, Explore Careers, Find Sponsor, View Sponsor Applications, Attend Safety Training, Register with Ministry, Complete Training Agreement, Apply for In-Class Training, View In-Class Training, Apply for Grants/Loans, Employment Insurance, Resources for In-Class, Track Hours, Track Skills, View Progress, Manage sign-offs, Submit Logbook, Register for Exam, Resources for Exam, Schedule Exam, View Results, Apply for Grants, Personal Profile, Sponsor Information, Membership & Certifications, and View Notifications.

5. The method of claim 3 wherein the Ministry View Portal can modify or access items from a list containing at least one of Offer Safety Training, Manage Registrations, Manage Training Agreements, Reporting, Manage In-Class Training, Manage Apprentice Supports, View Apprentice Progress, Manage Logbooks, Manage Hour Requirements, Offer Exam, View Apprentice Results, View Apprentices, View Training Agreements, View Memberships, Personal Profile, Company Profile, and View Notifications.

6. The method of claim 3 wherein the Employer View Portal can modify or access items from a list containing at least one of Offer Sponsorship, Manage Potential Apprentices, Offer Safety Training, Register with Ministry, Complete Training Agreements, Send Apprentice for In-Class Training, Apply for Grants or Loans, Employment Insurance, Manage Apprentice Supports, Track Hours, Track Skills, Manage Sign Offs, View Apprentice Progress, View Apprentice Results, View Apprentices, View Training Agreements, View Memberships, Personal Profile, Company Profile, and View Notifications.

7. The method of claim 3 wherein the Training Agent View Portal can modify or access items from a list containing at least one of Offer Safety Training, Manage In-Class Training, Schedule Placement Tests, Manage Apprentice Supports, View Apprentice Progress, View Apprentices, View Training Agreements, View Memberships, Personal Profile, Company Profile, and View Notifications.

8. A computer server apparatus for processing apprenticeship credentials incorporating:
an apprenticeship identifier that uniquely identifies a student;
a database that uses the apprentice identifier as an index to store data records associated with that apprentice;
a plurality of portals that allow for stakeholders in the apprentice data records to have access to view a plurality of controlled subsets of the apprentice data records;
a mechanism for at least one of the portals to update the data records associated with the apprentice identifier;
a mechanism for calculating and displaying an indication of the level of credential that the student has met; and
access for at least the regulatory agency to interrogate the apprenticeship credentials.

9. The server of claim 8 wherein the indication of the level of credential can be accessed by at least one of the apprentice, the employer, and the training agent.

10. The server of claim 8 wherein the training agent access is further restricted to a list of training agents selected by the apprentice.

11. A method of predicting whether the capacity of apprenticeship training or trades training is adequate, the method comprising:
creating a database of apprentices enrolled in apprenticeship or trades training programs in a geographic region;
acquiring information regarding the training requirements for each of the apprenticeship or trades training programs in which the apprentices are enrolled;
identifying the number of apprentices that have met the pre-requisites for a specific training program;
identifying the number of apprentices that have greater than a threshold probability of completing the pre-requisites before the training program is offered;
relaying the information regarding the number of apprentices to at least one Training Agent; and
identifying if the training capacity in any geographic region is adequate to train all of the probably qualifying apprentices.

12. The method of claim 11 wherein the comparison is made for a plurality of apprenticeship programs with a common training program.

13. The method of claim 11 wherein the threshold probability of completing the pre-requisites is adjustable based on at least one factor.

14. The method of claim 11 wherein the at least one factor is chosen from a list including past pre-requisite training completion for each individual apprentice, historical pre-requisite completion rates for similar apprentices, seasonal pre-requisite completion rates, and economic environment.

15. (canceled)

16. (canceled)

17. (canceled)

18. (canceled)

19. (canceled)

20. (canceled)

21. (canceled)

22. (canceled)

23. (canceled)

24. (canceled)

25. The server of claim 1 wherein the training agent access is further restricted to a list of training agents selected by the apprentice.

26. The method of claim 1 further comprising creating a portal which allows for the apprentice to obtain information on credential requirements, and which further allows for the apprentice to register for an apprenticeship or trades training program.

27. The server of claim 8 further incorporating a mechanism for an apprentice to register for an apprenticeship or trades training program.

28. The server of claim 8 further incorporating a mechanism for an apprentice to register for an apprenticeship or trades training program.
